(19) United States
(12) Patent Application Publication
(10) Pub. No.: US 2005/0251483 A1
(43) Pub. Date: Nov. 10, 2005

(54) Transaction method of digital data and system thereof

(75) Inventors: Seok Gu Yun, Anyang (KR); Young Lee, Anyang (KR); Seung Hwan Shin, Seoul (KR)

Correspondence Address: DILWORTH & BARRESE, LLP, 333 EARLE OVINGTON BLVD., UNIONDALE, NY, 11553, US

(73) Assignee: TERTEN, INC., Seoul (KR)

(21) Appl. No.: 11/114,690

(22) Filed: Apr. 26, 2005

(30) Foreign Application Priority Data
Apr. 26, 2004 (KR) 10-2004-0028783
Mar. 11, 2005 (KR) 10-2005-0020413

(51) Int. Cl. G06F 17/60

(52) U.S. Cl. 705/52

(57) ABSTRACT

Disclosed is a transaction method including a digital data seller client system, a digital data purchaser client system and a digital data transaction server. The transaction method according to the invention includes the steps of: inputting digital data including information on a seller, information on digital data, information on transactional functions, and digital data in the digital data transaction server by the digital data seller client system; publicizing the information on digital data and the information on transactional functions of the digital data on-line by the digital data transaction server; selecting an authenticated function from the information on transactional functions to use the digital data from the digital data transaction server by the digital data purchaser client system; encoding the digital data and a list of authenticated functions and transmitting the same to the digital data purchaser client by the digital data transaction server; and transmitting decoding means for decoding the encoded data to the digital data purchaser client system by the digital data transaction server.

### PRIORITY

This application claims priority to an application entitled “Transaction Method of Digital Data and System Thereof” filed in Korean Industrial Property Office on Apr. 26, 2004 and assigned Ser. No. 2004-28783, and to an application entitled “Transaction Method of Digital Data and System Thereof” filed In Korean Industrial Property Office filed on Mar. 11, 2005 and assigned Ser. No. 2005-20413, the contents both of which are hereby incorporated by reference.

### BACKGROUND OF THE INVENTION

1. Field of the Invention

The present invention relates to a transaction method of digital data, and in particular, a method of blocking illegal reproduction and distribution of digital data by fundamentally blockading the functions of reproducing, printing or transmitting without any authentication when decoding and executing encoded digital data files as well as a method of optionally purchasing and using desired functions only when executing digital data.

2. Description of the Related Art

Recent days, the acts of generating and distributing valuable information in the form of electronic data have emerged as economically significant issues. In particular, owing to development of the communication system such as Internet, such digital data began to be recognized as goods that can be transacted on-line.

However, the digital data such as music files, image files, document files, etc. are vulnerable to illegal reproduction and transmission. Therefore, illegal reproduction or transmission of the digital data needs to be technically restricted to make the digital data an object of transaction. However, it is a reality that the current technology does not provide any particular means to fundamentally blockade such illegal acts.

Also, inconvenience must be eliminated for the user who pays a reasonable cost of using so that the digital data can become an object of ordinary transaction. Further, more active distribution of digital data could be realized if the payments can be discriminated depending on the degree of using, i.e., merely reading, or reproducing or transmitting the digital data.

In short, cost-flexible transaction and more active distribution of digital data could be encouraged by blockading illegal use of the digital data enabling the users to pay only for a particular right of using a single digital data.

### SUMMARY OF THE INVENTION

It is, therefore, an object of the present invention to provide a method of preventing illegal use of digital data.

It is another object of the present invention to provide a method of safely distributing digital data.

It is still another object of the present invention to provide a method of controlling functions of executing necessary digital data within the scope as purchased or acquired by a user so as to encourage more active distribution of digital data.

In carrying out the invention and according to one aspect thereof, there is provided a transaction method of digital data including a digital data seller client system, digital data purchaser client system, and a digital data transaction server, the method including the steps of: inputting digital data including information on a seller, information on digital data, information on transactional functions in the digital data transaction server by the digital data seller client system; publicizing the information on digital data and the information on transactional functions of the digital data on-line by the digital data transaction server; selecting an authenticated function from the information on transactional functions to use the digital data from the digital data transaction server by the digital data purchaser client system; encoding the digital data and a list of authenticated functions and transmitting the same to the digital data purchaser client by the digital data transaction server; and transmitting a decoding module for decoding the encoded data, a file identifier determination module for identifying the digital data, a hooking module for hooking a command to execute the digital data, and an authenticating module to the digital data purchaser client system by the digital data transaction server.

The digital data purchaser client system performs the steps of: recognizing the encoded digital data by means of the file identifier determination module; decoding the encoded digital data on a main memory of the system by means of the decoding module; loading an execution program for executing the decoded digital data on the main memory; analyzing the loaded execution program and recognizing a necessary function module; supplying the authenticating function module to the main memory; changing a call destination address for calling the necessary function module to an entry point address of the authenticating function module by means of the hooking module; executing the authenticating function module instead of the necessary function module when the necessary function module is called in the course of executing the decoded digital data by the execution program; decoding the encoded list of authenticated functions by means of the decoding module, and loading the same on the main memory; determining whether or not the necessary function module belongs to the list of authenticated functions; calling and executing the necessary function module called by the execution program, if the called necessary function module is determined to belong to the list of authenticated functions, and not executing the called necessary function module, if determined otherwise.

According to another aspect of the invention, there is also provided a transaction method of digital data to transact each function of an execution program for executing the digital data on-line.

For safer distribution of the digital data, the digital data purchaser client system may further include the steps of receiving authentication by the user through an access to a remotely located server system, and receiving the decoding means for decoding the encoded digital data prior to the step of decoding the encoded digital data in the main memory of the computer system.

The execution program code includes an import address table (IAT), which enlists the necessary function modules required for execution. The step of recognizing a necessary function module by analyzing the loaded execution program may be a step of recognizing the IAT by analyzing the same. The IAT may further call the necessary function module required for execution from the execution program code. The step of changing a call destination address for calling the necessary function module from the execution program to the entry point address of the authenticating function module may be a step of changing a call destination address of the IAT to the entry point address of the authenticating function module.

For safer distribution of the digital data, the step of executing the authenticating function module may further include the steps of receiving authentication by the user through an access to a remotely located server system, and receiving a list of the authenticated necessary function modules from the server system, if authenticated as a lawful user, prior to the step of loading the list of necessary function modules authenticated by the decoded digital data.

The list of authenticating function module is an encoded file. For safer distribution of the digital data, the step of executing the authenticating function module may further include the steps of receiving authentication through an access to a remotely located server system by a user, and receiving a list of the authenticated necessary function modules from the server system, if authenticated as a lawful user, prior to the step of loading the list of necessary function modules authenticated by the decoded digital data.

The necessary function modules as referred to in the present invention mean all the modules required to execute general programs by a computer. For example, the modules performing at least any one function of executing the programs such as screen viewing, screen storing, screen printing, file editing, file storing, file transmitting, file printing, file encoding, file decoding, sound executing, mobile image executing, an interpreter module required for java script, etc. The digital data as referred to in the present invention may be at least one or more data among the execution program code, image data, text data, sound data, still screen data, or image data.

According to another aspect of the invention, there is also provided a computer program including: decoding means for decoding encoded digital data on a main memory of the computer system; necessary function module recognition means for analyzing the execution program loaded on the main memory, and recognizing a necessary function module; authentication means for authenticating operation of the necessary function module; address changing means for changing a call destination address of a code for calling the necessary function module among the execution codes of the execution program loaded on the main memory to an entry point address of the authentication means; a list of necessary function modules authenticated as being available with respect to the decoded digital data; determination means for determining whether or not the necessary function module authenticated as being available with respect to the decoded digital data belongs to the authenticated list of necessary function modules.

### BRIEF DESCRIPTION OF THE DRAWINGS

The above object, features and advantages of the present invention will become more apparent from the following detailed description when taken in conjunction with the accompanying drawings, in which:

FIG. 1 is a block diagram illustrating systems required for a transaction method of digital data according to the present invention;

FIG. 2 is a block diagram illustrating the steps of operating the system for each transactional subject according to the present invention;

FIG. 3 is a block diagram illustrating construction of a transaction server according to the present invention;

FIG. 4 is a flowchart illustrating the steps of transaction according to the present invention;

FIG. 5 is a block diagram illustrating construction of a purchaser client system, in which a docushell engine (DSE) is installed, according to the present invention;

FIG. 6 is a flowchart illustrating the steps of executing digital data by means of the DSE according to the present invention;

FIG. 7a is a block diagram illustrating the steps of hooking according to a conventional art;

FIG. 7b is a block diagram illustrating the steps of hooking according to the present invention; and

FIG. 8 is a block diagram illustrating the steps of blockading hacking according to the present invention.

### DETAILED DESCRIPTION OF THE INVENTION

Best modes for carrying out the present invention will now be described with reference to the accompanying drawings. In the following description, same drawing reference numerals are used for the same elements even in different drawings. The matters defined in the description are only provided to assist in a comprehensive understanding of the invention. Thus, it is apparent that the present invention can be carried out without those defined matters. Also, well-known functions or constructions are not described in detail since they would obscure the invention in unnecessary detail.

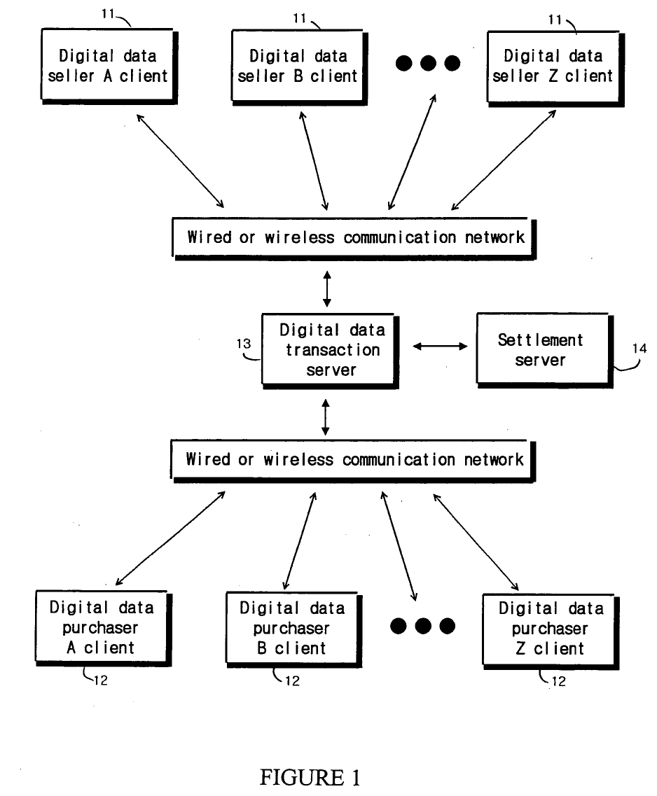

FIG. 1 is a block diagram illustrating systems required for a transaction method of digital data according to the present invention.

FIG. 1 divides the systems into two categories of suppliers and consumers, i.e., digital data seller client systems 11 for manufacturing and selling digital data, and digital data purchaser client systems 12 for purchasing such digital data. A transaction server 13 exists between the two systems to facilitate their transactions by providing a transaction screen, which displays a list of digital data and a brief summary of the list supplied by the seller client system, and by processing the transaction with respect to a request for transaction from the purchaser client system. Apart from the transaction server 13, a settlement server 14 of banks, credit card companies, etc. are linked to the systems to authenticate purchasers and transactions as well as to perform virtual settlements from the bank accounts of the purchasers.

Referring to FIG. 1, each client system 11 or 12 may be connected to the transaction server in wired or wireless manner. Each client system may be any kind of apparatus comprising hardware capable of uploading, downloading or displaying the digital data on a screen, inputting and processing transactional commands or conditions, such as computers, mobile phones, PDAs, etc. The hardware-wise construction of the present invention is quite similar to the system used for on-line transactions of tangible goods, such as Internet shopping malls. Therefore, detailed description will be omitted except extraordinary cases.

The digital data meant by the present invention includes any kinds of transmittable digital data. For example, execution program codes that are executable per se and carrying economic values while being transmittable and distributable on-line. Specifically, games or utility application programs, text data drafted with Hun Min Jeong Eum or Acrobat™, etc., sound or music files of MP3 or other formats, image data such as still image or mobile image files, multimedia data mixing the above data.

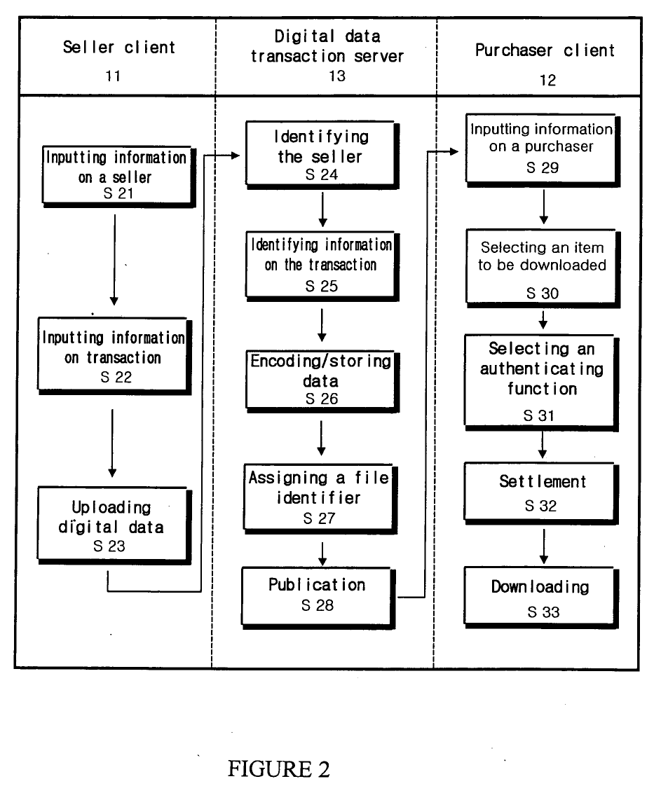

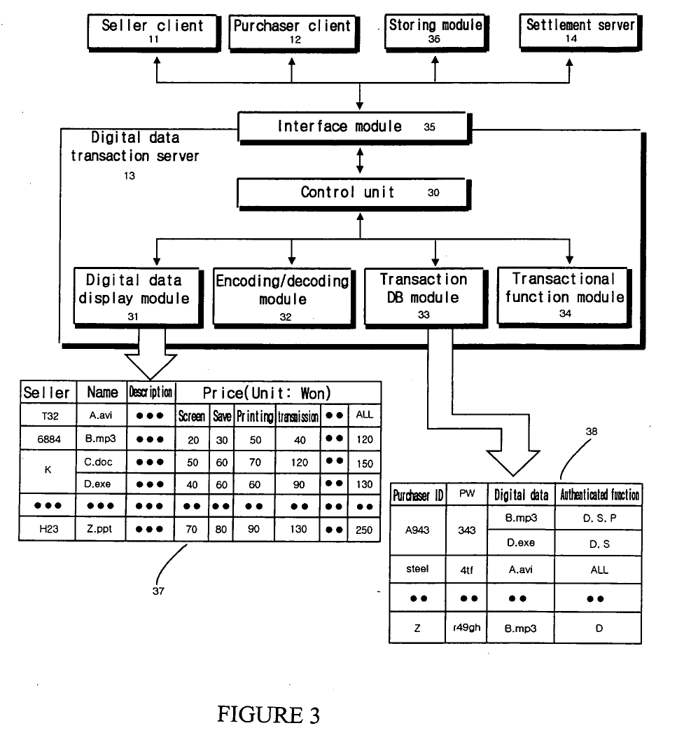

FIG. 2 shows each step of operating the system for transacting digital data according to the present invention, and FIG. 3 shows modules constituting the transaction server.

In the seller client system, a seller accesses the transaction server and requests provision of a transaction screen. Then, the transaction server transmits the transaction screen to the seller. The transaction screen performs a cyber market function to transact digital data. For instance, the transaction screen may be provided in the form of wired web pages or wireless WAP pages, etc.

The seller client who has accessed the transaction screen first inputs information on the seller (S21). Here, the information on the seller includes a seller's ID or an IP address of the seller client system, original device information on the seller client system, etc. Inputting such information on the seller is to confirm information on the seller's account when settlement will be performed in the future.

Here, the original device information of the system means a product serial number of the computer's operating system or the CPU, or a memory stick information on smart card that will be provided in the form of memory stick. The original device information of the system is to identify the transactional subject based only on the computer system executing the digital data irrespective of the user. For example, more active transactions and use of digital data can be induced by allowing a holder of the same user ID, the same IP or the same computer system or the same smart card to use the same digital data irrespective of the place in accordance with the seller client system 11 or the transaction server 13. Same conditions are applied to the purchaser client system 12. Hereinafter, such information on the transactional subject will be referred to as simply the ‘seller information’ and the ‘purchaser information.’

The seller client system which has inputted the seller information inputs digital data information on the digital data to be transacted thereafter on the transaction screen (S22). Here, the inputted digital data information is the general information on the transactional subject to enable the purchaser to fully recognize the corresponding digital data prior to transaction, e.g., title of the digital data to be transacted, brief summary of the digital data, classification of the category, keyword to be used for search, etc.

In addition, the seller inputs functions that can be transacted along with the accompanying selling conditions. Hereinafter, the functions that can be transacted and the selling conditions will be referred to as the ‘information on transactional functions.’

In the present invention, the information on transactional functions means the selling conditions such as a price set by the seller for each function, e.g., an executing function of simply viewing or listening the digital data to be transacted, a storing function of storing the digital data provided in the manner of stream in one's own file system, a printing function of printing the digital data and outputting it on paper, a transmitting function of transmitting the digital data to a third party. All of such information on transactional functions has been allowed to a single digital contents to date.

The present invention is to provide a method of maximizing commerciality of the digital data by classifying each function and authorizing different purchasers to perform different functions with respect to the same digital data, while preventing performance of any more functions than authorized.

After inputting the information on transactional functions, the seller uploads digital data, which is a transactional subject (S23).

The uploading and inputting of the information on transactional functions may be performed in a reversed order.

The transaction server 13 receiving the inputted information classifies the sellers of digital data based on the information inputted in the step S13 of inputting seller information, and recognizes information on settlement accounts, etc. (S24). The transaction server 13 also identifies information on the corresponding digital data based on the information inputted in the step S22 of inputting digital data information (S25), and identifies the information on transactional functions through interlocking. Here, to identify means to recognize the information necessary for handling the digital data, which is an object of operation by the transaction server, such as receiving, interlocking, storing and publicizing the inputted information, etc., to distribute the digital data.

Then, the transaction server performs an encoding process by means of the encoding/decoding module to prevent illegal reproduction and distribution of the digital data, and stores the same in the storing module interlocked with the transaction server (S26). The transaction server then publicizes the digital data information on Internet in wired or wireless manner, or on a transaction screen provided by a private network (S28). When encoding and storing the digital data, the transaction server also assigns an identifier to the digital data so that the digital data can be recognized as the one encoded and sold by the transaction server and be distinguished from the other documents in the future (S27).

Operational mechanism of the purchaser client system 12 will now be described. The purchaser client system 12 accesses the transaction server 13, and reads transactional information of the digital data, which can be transacted, to select the digital data to be transacted. Before or after the selection, the purchaser client system provides the purchaser information and the settlement information to satisfy the basic transactional requirements (S29).

The purchaser client system then designates the digital data to be transacted, and selects the same as an item to be downloaded (S30). Thereafter, the purchaser client system selects an authenticated function to determine as to which function will be performed for the digital data (S31), and approves settlement for purchase of the function based on the transactional information (S32). Upon completion of the settlement, the purchaser client system becomes ready to download and use the selected digital data (S33).

FIG. 3 shows a best mode for constructing a module of the transaction server.

Referring to FIG. 3, the transaction server 13 comprises: a digital data display module 31 for supplying information 37 on the object of transaction to the client system as a part of the transaction screen; an encoding/decoding module 32 for encoding the digital data per se, which is an object of transaction, and storing the same in the storing module and supplying decoding means; a transactional DB module 33 for storing the digital data and information on the seller and/or the purchaser interlocked therewith; a transaction performing module 34 for performing general functions related to transactions, including the functions of uploading the data and transactional conditions from the seller client system 11, and performing settlement by connecting the settlement server 14 with respect to a request for transaction from a purchaser, and transmitting to the purchaser client system 12 the corresponding digital data and decoding means, a list of functions authenticated to the purchaser, and safety engine in the form of an application program as provided according to the present invention, etc.; a control section 30; and an interface module 35 for communication with each client system, storing module and settlement server, etc. Here, it is out of question that the storing module 36 and the settlement server 14 may be included inside of the transaction server depending on the construction.

FIG. 3 shows a best for a screen 37 of the object information as the transaction screen. The seller can input and present transactional conditions such as a title of the digital data uploaded by himself/herself, a brief summary of the digital data, functions that can be transacted, etc. While viewing the screen 37, the purchaser can request a purchase and transmit the settlement information, such as an amount to be settled, to the transaction server 13 by setting a necessary object and conditions.

FIG. 3 exemplifies the screen 37 displaying the price for each function such as executing, storing, transmitting, etc. Paying the price for each item and purchasing a particular function become an authenticated function and are stored in the list of authenticated functions with respect to the corresponding digital data of the corresponding purchaser. To be specific, the list of authenticated functions means a list of the functions that can be executed by the purchaser only with respect to the corresponding digital data apart from purchasing of the corresponding digital data. Construction of such list of the authenticated functions is for reasonable compensation for a copyright of the digital data that might be infringed if a purchaser purchases such functions and performs a function of reproduction or transmission, in consideration of the functions such as transmission or reproduction of the digital data that might infringe the copyright of the copyright holder of the corresponding digital data.

Hereinafter, the authenticated functions will be distinguished from the unauthenticated functions. The concept integrating these two functions will be referred to as the ‘necessary functions.’ The necessary functions that can be transacted may be the accompanying conditions of each function, in addition to the ones as shown in the drawings, e.g., period of use, etc.

FIG. 3 also shows a best mode for constructing the digital data stored in the transactional DB module 33. For example, if a purchaser requests a particular digital data by storing his/her own ID and password to be interlocked with the digital data, the purchaser undergoes an authentication process as to whether or not he/she has a right to download and decode the corresponding digital data. Also, a list of the authenticated functions is stored to authenticate what kind of functions only can be executed with respect to the digital data. The list is constructed to be referred to when confirming authentication of the authenticating function module that will be described later. According to the example in FIG. 3, the purchaser having an ID of A943 has purchased the functions of D (screen display) and S (save) only with respect to the digital data of D.exe. Thus, this purchaser is authenticated to have the D and S functions only according to the list of authenticated functions. If this purchaser attempts to execute other functions than authenticated with respect to D.exe, such as P (printing) function for example, the printing function is not performed or processed to be an error by the safety engine of the present invention.

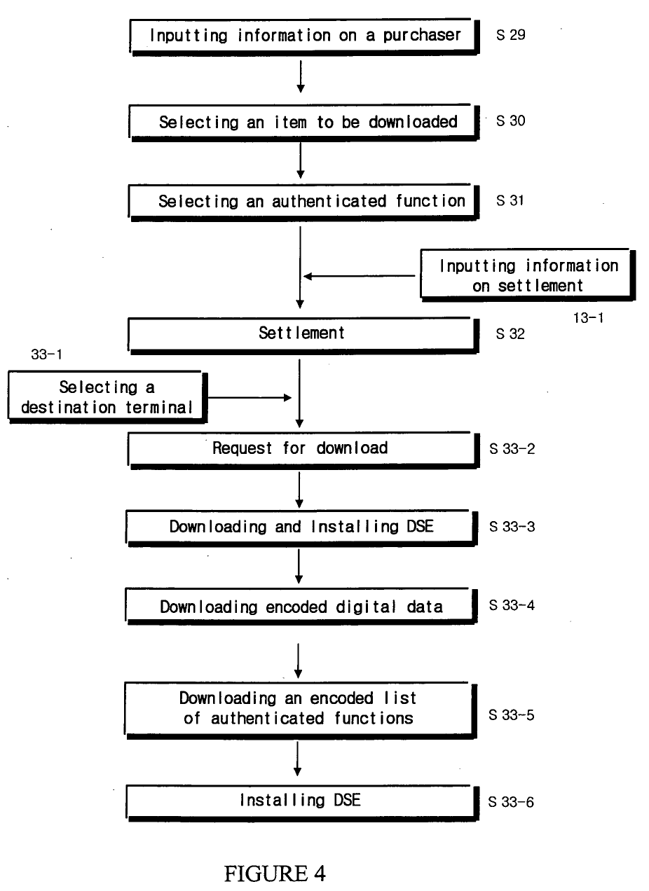

FIG. 4 is a flowchart of the purchaser client system 12 specifying the purchasing steps of S29 to S33. The purchaser first accesses the transaction server by means of a communication device such as a personal computer, a mobile phone, a PDA, etc. which is connected to Internet, etc. as a purchaser client system. The purchaser then inputs the purchaser information to undergo an authentication process (S29). Before or after the authentication, the purchaser receives a transaction screen from the transaction server to search the digital data, which is an object of transaction.

After selecting an object to be downloaded and the necessary functions required, i.e., a list of authenticated functions (S30, 31), the purchaser should undergo a settling process to download the object (S32). The settlement can be made in diverse manners such as by paying with cyber money or by subscribing a paid advertisement according to the policies of the transaction server. When settlement is to be performed by means of real money, the purchaser may use the pre-stored settlement information on the corresponding user or newly input settlement information upon each transaction (S32-1).

Before or after the settlement, the purchaser may undergo a step of selecting a terminal to download the selected digital data, i.e., a destination terminal (S33-1). This is because a third party's client system can also be selected as a target terminal when sending a particular music file to a friend, for example, though the accessed client system generally becomes a destination terminal. Unless stated otherwise hereinafter, the description will now be made under an assumption that the purchaser client system purchasing the digital data is identical to the destination terminal.

Once the settlement and selection of the destination terminal are completed, the purchaser then proceeds with the downloading step. If the purchaser requests downloading (S33-2), the digital data is downloaded along with the safety engine and the list of authenticated functions, which are necessary for the transaction in the present invention, in encoded format, although it might appear to the purchaser's eyes as if the digital data only is downloaded (S33-3, S33-4, S33-5).

Hereinafter, the safety engine will be referred to as a ‘docushell engine’ or a ‘DSE,’ which was particularly named by the inventor upon its first development for the transaction according to the present invention. The DSE is constructed to be automatically installed in the client system upon completion of the downloading process (S33-6). When the system begins to operate after being registered in the registry of the computer system, the DSE is always loaded on the main memory and processed so as to assist in and monitor use of the digital data by the purchaser.

In FIG. 4, downloading the list of authenticated functions may be executed after, rather than before, undergoing the authentication process only when the user wishes to use the corresponding authenticated functions. Further, the DSE also houses decoding means for decoding the encoded digital data. Hence, decoding or utilization of the digital data cannot be performed at all unless the DSE is installed through downloading.

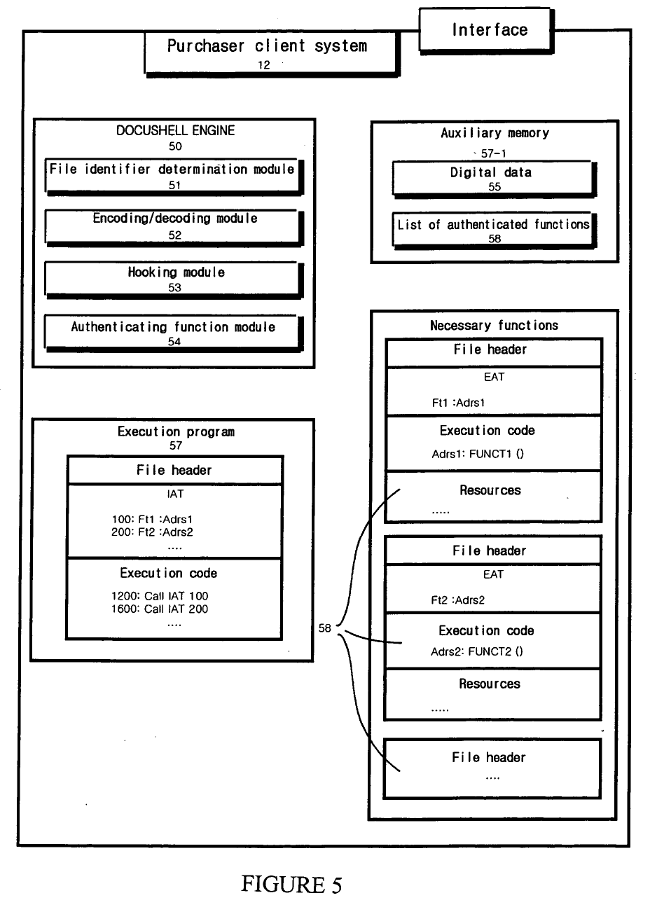

FIG. 5 shows a construction of destination terminal or the purchaser client system 12, in which the DSE is installed upon completion of the downloading process.

The downloaded digital data 55 and the list of authenticated functions 56 interlocked therewith are stored in an auxiliary memory 57-1, such as hard disk, in encoded format. The DSE 50 is installed in the destination terminal or the purchaser client system 12. The DSE 50 comprises a file identifier determination module 51, an encoding/decoding module 52, a hooking module 53 for hooking, and an authenticating function module 54 for performing authentication with respect to the necessary functions.

The modules in the DSE will now be briefly described. The file identifier determination module 51 is a module to determine the digital data to be affected by operating the DSE. For example, the file identifier determination module 51 distinguishes the digital data made by Power Point and transacted by the method according to the present invention from many other digital data made by Power Point. More specifically, the file identifier determination module 51 recognizes and distinguishes the file identifier assigned to a digital data when encoded by the encoding/decoding module 32 of the transaction server. The encoding/decoding module decodes the encoded digital data 55 downloaded on the purchaser's system as well as the list of authenticated functions, and encodes and stores the necessary data among the data recorded in the main memory with respect to an authenticated command by the user to store the corresponding digital data after use. The hooking module 53 is a module for performing an address remapping, which will be described later, after the execution program 50 to execute the digital data 55 and the necessary function module 58 are loaded on the main memory by a loader of the operating system. The authenticating function module 54 is a module for confirming whether or not the requested necessary function is an authenticated function as included in the list of authenticated functions. The hooking module 53 is a module required to operate the authenticating function module 54 according to the present invention. The operational methods of these two modules will be described later in detail.

FIG. 5 further exemplifies an execution program 57 to execute the digital data and necessary function modules 58 required by the execution program 57. The execution program 57 and the necessary function modules 58 are pre-installed in the client system.

Examples of the execution program and the necessary function modules will now be presented briefly. If the downloaded digital data is A.ppt, its execution program is powerpoint.exe, which is a program of Microsoft Inc. in the U.S. The necessary function modules may be a variety of dynamic loading library (DLL) files required by the powerpoint.exe.

Such necessary function modules may exist inside of the execution program as program codes or as independent modules such as DLL files. Regardless of its format, the execution code performing the necessary function modules is generally composed of an entry point, which is a start of execution, and a separate block including a return point, which returns execution after termination. Hereinafter, the execution code of a block format as described above will be referred to as the ‘necessary function module.’

With respect to the execution program, each of the necessary function modules independently performs auxiliary functions such as storing, transmitting, screen displaying, etc. Therefore, the execution program and the necessary function modules are mutually combined through an address mapping process on the main memory when processed for actual execution. For example, the necessary function modules recognize the respective necessary functions Ft1, Ft2 by analyzing an import address table (IAT) of the execution program, and read addresses Adrs1, Adrs2 of the necessary function modules called by the necessary functions Ft1, Ft2 from an export address table (EAT) to store the same in the IAT. Such functions are well known to the general public, and will be described later in further detail.

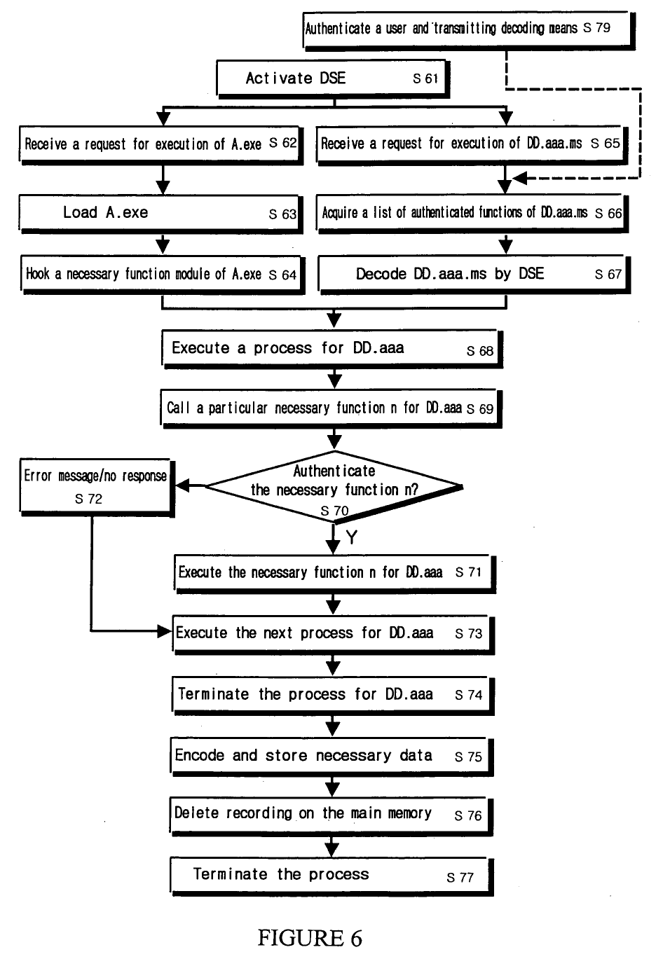

FIG. 6 is a flowchart illustrating the steps of executing digital data downloaded from the client system, in which the DSE and diverse modules are installed.

To assist in understanding, FIG. 6 exemplifies the execution program as A.exe; the digital data, which is an object of execution, as DD.aaa; and the encoded DD.aaa as DD.aaa.ms. It is out of question that such examples do not confine the present invention to any one particular format.

The DSE according to the present invention is generally processed before executing the execution program and the digital data because it is constructed in the registry to be installed at the time of installing a shell module after booting the corresponding client system. If necessary, however, the DSE may be processed by being loaded on the main memory upon receipt of a request for execution of a particular execution program (S62) or of a digital data having an identifier assigned by the transaction server according to the present invention, e.g., having ‘ms’ as a code identifier in FIG. 6.

The purchaser who is a user of the digital data DD.aaa may first request execution of the execution program A.exe, which is capable of executing the DD.aaa, and then request execution of the DD.aaa. Or, the purchaser may first request execution of the DD.aaa, and then the A.exe may be automatically executed by the operating system. Therefore, FIG. 6 arranged the step of requesting execution of the execution program and the next steps (S62 to S63) in parallel with the step of requesting execution of the digital data and the next steps (S65 to S67) to emphasize no priority.

Thus, no difference lies in executing the present invention even if any one of the DSE processing step S61, the step S62 of requesting execution of the execution program or the step 65 of requesting execution of the digital data is first proceeded with. The only prerequisite is that the DSE should be processed (S61) before loading the execution program on the main memory (S63) and executing the digital data (S67).

When an execution of the execution program has been first requested (S62) as shown in FIG. 6, the execution program is loaded on the main memory of the client system. Therefore, calling of the necessary function modules of the execution program is analyzed by the DSE, and the authenticating function module are hooked through address remapping to operate instead of the necessary function modules.

Before or after taking the steps S62 to S64, the purchaser requests execution of the desired digital data (S65). In response to this request, the DSE decodes the digital data DD.aaa.ms encoded by the decoding module 52, which is a built-in module of the DSE so as to be loaded on the main memory (S67).

Another way of utilizing the decoding module is that, upon receipt of the request for execution of the digital data (S65), the transaction server connected to the client system once again authenticates, and transmits the decoding module, which is a module of the DSE, so as to take the decoding step (S79). This is a step of reconfirming authentication of the user as a lawful holder of right. Therefore, FIG. 6 exemplifies a case that the decoding module of the DSE is separately downloaded apart from the DSE.

Before or after taking the above steps, the user decodes a list of authenticated functions, which has been authenticated through settlement, and installs the same in the main memory. Here, the list of authenticated functions is in encoded state to prevent hacking by a third party. The present invention exemplifies a case that the list of authenticated functions is downloaded in advance and stored in the client system in encoded state. However, it is out of question that the list of authenticated functions can also be downloaded and installed after authenticating the user (S79). Hereinafter, these two cases will be referred to as the step S66 of acquiring the list of authenticated functions.

If the user has first requested execution of the digital data in the steps as shown in FIG. 6, the steps S62 to S64 of processing the execution program may be executed after the steps S65 to S67 of processing the digital data.

After performing the above initial steps, the execution program begins actual processing of the decoded digital data DD.aaa (S68). Here, the execution program calls the necessary function modules for displaying the data on a screen or to reproduce the same as a sound as well as for editing, storing or transmitting, etc. in accordance with the user's command (S69).

If a particular necessary function module identified as the ‘necessary function module n’ is called by the execution program (S69), the authenticating function module 54 is called instead because such calling is hooked by the DSE in advance (S64). The authenticating function module 54 undergoes an authenticating step S70 to check whether or not the called necessary function module n is an authenticated function by reference to the decoded list of authenticated functions.

If the called necessary function module n is determined to have been authenticated, the authenticating function module 54 calls the necessary function module n so as to be executed in an ordinary manner (S71). If the called necessary function module n does not exist in the list of authenticated functions, however, the authenticating function module either ignores the calling or generates an error message (S72) to return to the execution program again (S73), thereby blocking the unauthenticated function. Such calling of the necessary function modules may be performed repeatedly, and the authenticating function modules are also repeatedly executed each time (S69 to S72).

Upon completion of all the steps (S73), the execution with respect to the DD.aaa of the execution program is terminated (S74). If necessary, the DSE encodes the digital data recorded in the main memory to store the same in the file system (S75). Or, the DSE completely removes the digital data from the main memory (S76) to prevent hacking of the decoded digital data.

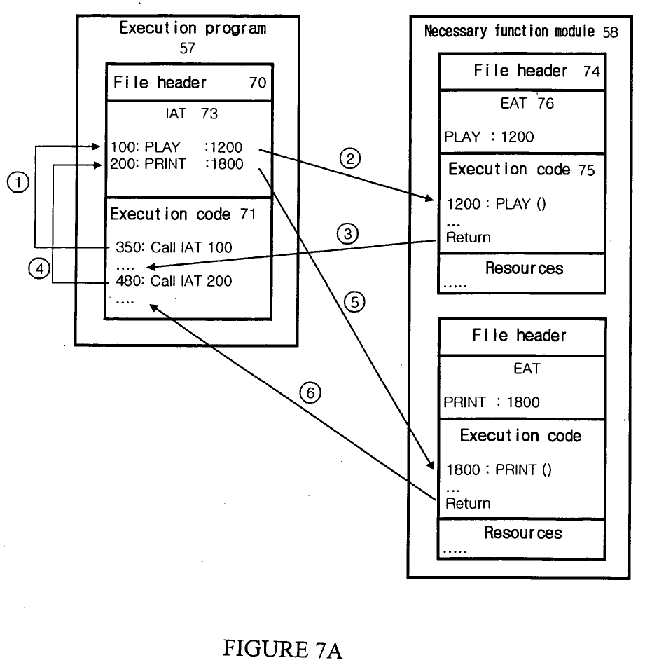

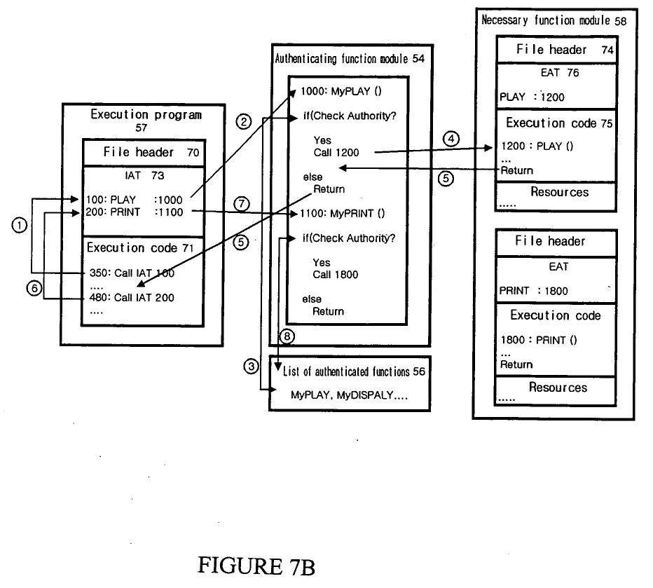

FIG. 7a illustrates the steps of operating the execution program according to a conventional art, and FIG. 7b illustrates the steps of operating the execution program, and in particular, the hooking step S64 and the authenticating steps S70 to S72 according to the present invention.

Referring to FIG. 7a showing the conventional art, the execution program 57 is classified into a file header 70 explaining the execution program 57 and an execution code block 71, which is a code to be virtually executed. The execution program also comprises an import address table (IAT) 73 enlisting a calling address with respect to the code block, which is referred to as a function called by the execution code 71, i.e., the necessary function module according to the present invention.

The necessary function module 58 comprises a file header 74 and an execution code block 75, which is a code to be virtually executed, and an export address table (EAT) 76 recording an entry point address of the execution code block.

The operation of the execution program will now be described. All the codes of the execution program 57 are first loaded on the main memory. The operating system of the system maps an address of the necessary module required by the execution program by parsing the execution code block 71 or analyzing the IAT 73 either directly or indirectly. For instance in FIG. 7b, an address 350 calls a necessary function module ‘PLAY’, while an address 480 calls a necessary function module ‘PRINT.’ As a necessary function module to call these modules, DLL files ‘PLAY.dll’ and ‘PRINT.dll’ are aligned in the main memory. By reference to each EAT, absolute addresses such as 1200 and 1800 are recorded in the IAT 73 of the execution program.

The DLL file is a function module constructed to be commonly used by diverse kinds of execution programs. The DLL file, which has been developed to reduce size of the execution programs and to enhance efficiency of execution, is a function module generally used under the present Windows operating system. The present invention exemplifies the DLL file as a necessary function module. However, any kind of function code block may be a necessary function module according to the present invention if the function code block is constructed to return to the main program after being called in the same manner and performing a particular function.

After recording of the IAT, the execution code of the execution program is virtually executed in CPU, and calls a PLAY function module at the address 350 (Step \mathring{1}). However, such call is not actually a call of the functional name but a call of a code line corresponding to the IAT 73. In FIG. 7b, the execution code calls the address 100.

The code of IAT having the address 100 is mapped to an address 1200 in advance so as to call the PLAY.dll. Therefore, executing the address 100 by jumping the step \mathring{1} will be led to a call of the address 1200 (step \mathring{2}). After the PLAY.dll is virtually executed in the code having the address 1200, the execution program code is returned by a return command (step \mathring{3}).

Thereafter, the execution program code is continuously executed. If the execution program code is called by the PRINT.dll function module while executing a code of the address 480, the steps \mathring{4} to \mathring{6} are performed as described above.

FIG. 7b illustrates a manner of performing re-direction of a call of the function module to the authenticating function module by hooking the call.

After the execution program code is loaded on the main memory, the operating system maps an address of the necessary function module of the IAT 73. Immediately after or before the processing step of the execution program, a hooking step S64 is performed by a hooking module 53 (not shown in FIG. 7b).

The hooking module 53 corrects the calling address of the IAT. As shown in FIG. 7a for example, the hooking module 53 corrects call destination of the code of address 100 of IAT, which was determined by the operating system to call the address 1200 for execution of the PLAY.dll, to the address 1000. The hooking module 53 then aligns the authenticating function module 54, which corresponds to the PLAY.dll, in the address 1000 instead of the PLAY.dll.

The hooking step S64 is terminated with correction of the calling addresses of the IAT so as to undergo the same process with respect to the call of the other necessary functions. Then, the execution program becomes ready to the user's command and work in an executable state.

Thereafter, calling of the PLAY.dll by the address 350 at the time of executing the execution program is led to a jumping to the address 100 of the IAT (step 1) and calling of the address 1000 (step \mathring{2}), which is an address manipulated by the hooking module.

The code of address 1000 is not an entry point of the PLAY.dll but an entry point of the MyPLAY.dll, which is an authenticating function module of the present invention. Therefore, the authenticating function module is first executed. Here, the authenticating module performs a step S70 of authenticating whether or not the PLAY.dll called by the execution program corresponds to a necessary function module as recorded in the authenticating function list, i.e., a necessary function lawfully purchased or acquired by the user.

The authenticating method is as shown in FIG. 7b. If the authenticating function module 54 calls the list of authenticated functions 56, the list of authenticated functions searches the list of its own to check whether or not the MyPLAY.dll has been authenticated. The authenticating function module 54 then transmits the result value to the authenticating function module 54 (step 3). It is also possible to prepare for authentication by pre-storing the result value in each authenticating function module 54 based on the value recorded in the list of authenticated functions 56. The DSE of the present invention performs such pre-storing of the result value in the authenticating function module 54.

Another authenticating method is as follows. The purchaser client system 12 accesses the transaction server 13 at the time of executing the authenticating function module 54. The purchaser client system 12 then requests an authentication result value with respect to the authenticating function module to the transaction server 13 so as to receive the result value. In that case, the authenticating function module 54 is not transmitted to the purchaser client system 12 from the beginning but is merely stored in the transaction DB module 33 of the transaction server 13 until responding to a call. This is a safest method for prevent hacking.

If the called necessary function module is determined to be included in the list of authenticated functions, the authenticating function module 54 then calls the code of address 1200, which is an address of the PLAY.dll so as to be executed (step \mathring{4}). The PLAY.dll is then executed, and the commanding right thereof is returned to the execution program again through the authenticating function module 54 (step \mathring{5}).

Calling of the necessary function PRINT.dll while executing the code of address 480 in the course of executing the execution program is led to a jumping to the address 200 of IAT (step \mathring{6}), and then to a call of address 1100, which is an address manipulated by the DSE (step \mathring{7}) so as to undergo an authenticating process with respect to the PRINT function module. At this time, the same authenticating process is performed (step \mathring{8}). If the result value is negative, the PRINT.dll located at address 1800 is not executed. Rather, either an error value or no response is shown to be ready to a next command of the execution program (step \mathring{9}).

The DSE blockades execution of unauthenticated necessary functions by the purchaser through the above process, thereby achieving safe performance of the transaction method according to the present invention.

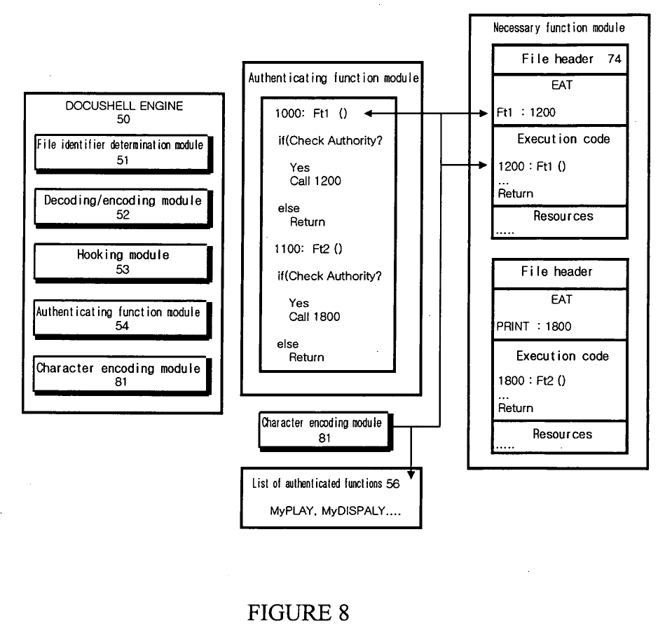

FIG. 8 exemplifies another mode of carrying out the present invention, i.e., the steps of blockading hacking attempted to incapacitate the operational mechanism according to the present invention as described above.

A hacker who has understood an operational mechanism of the present invention can imitate a hooking module similar to that of the DSE according to the present invention. To be specific, a hacker module can incapacitate the DSE of the present invention by correcting the calling address of IAT of the execution program as corrected by the DSE. For example, if the DSE of the present invention corrects the “100:PLAY:1200” to be “100:PLAY:1000” as shown in FIG. 7b, the hacker module can restore the corrected address to be “100:PLAY:1200” again to skip the authenticating function module.

As a remedy thereof, the mode in FIG. 8 further comprises a character encoding module 81 in addition to the DSE. To be specific, the DSE of the present invention searches a text data “PLAY” or “PRINT” as recorded in the IAT or the DLL to correct an address to be manipulated. However, most of the hacker modules would search the name of such function modules to correct the same address. Therefore, it is critical to disable the hacker modules not to locate the corrected address by erasing the text data, which are the names of the necessary function modules, or changing the names to completely different ones after performing the hooking step by means of the character encoding module 81.

For example, as shown in FIG. 8, the DSE of the present invention searches the text data of “PLAY” or “PRINT,” which is a function module necessary for the IAT. The character encoding module 81 then corrects the called addresses to the addresses of the authenticating function modules, and searches all parts of the main memory recording the names of the function modules to change the names to completely different ones such as “Ft1” or “Ft2”, etc.

Changing the address by a hacker module before hooking by the DSE would be meaningless because the address would be changed again later by the DSE. Hence, the hacker module would approach the address only after operation of the DSE. However, the hacker module would not be able to find the names of the function modules necessary for the hacker module due to an operation of the character encoding module. Thus, the hacking would fail.

The present invention providing a transaction method of digital data on-line has an advantageous effect of realizing transaction of various kinds of digital data with diverse options.

The present invention has another advantageous effect of blockading hacking or illegal reproduction of digital data, which is emerged as the most serious problem in distribution of digital data, by guaranteeing safe execution of the digital data.

The present invention has another advantageous effect of establishing healthy and diverse commercial rules in the transaction of digital data on-line. As a consequence, social and technical atmosphere can be created to produce more developed kinds of digital data.

While the invention has been shown and described with reference to certain best modes to carry out the invention, it will be understood by those skilled in the art who has understood the technical concept of the present invention that various changes in form and details may be made therein without departing from the spirit and scope of the invention as defined by the appended claims, e.g., one or more authenticating steps may be set so as to be selected whenever necessary.

1. A transaction method of digital data including a digital data seller client system, a digital data purchaser client system, and a digital data transaction server, the method comprising the steps of:
inputting digital data including information on a seller, information on digital data, information on transactional functions, and digital data in the digital data transaction server by the digital data seller client system;
publicizing the information on digital data and the information on transactional functions of the digital data on-line by the digital data transaction server;
selecting an authenticated function from the information on transactional functions to use the digital data from the digital data transaction server by the digital data purchaser client system;
encoding the digital data and a list of authenticated functions and transmitting the same to the digital data purchaser client by the digital data transaction server; and
transmitting decoding means for decoding the encoded data to the digital data purchaser client system by the digital data transaction server.

2. A transaction method of digital data including a digital data seller client system, a digital data purchaser client system, and a digital data transaction server, the method comprising the steps of:
inputting digital data including information on a seller, information on digital data, information on transactional functions, and digital data in the digital data transaction server by the digital data seller client system;
publicizing the information on digital data and the information on transactional functions of the digital data on-line by the digital data transaction server;
selecting an authenticated function from the information on transactional functions to use the digital data from the digital data transaction server by the digital data purchaser client system;
encoding the digital data and a list of authenticated functions and transmitting the same to the digital data purchaser client by the digital data transaction server; and
transmitting decoding module for decoding the encoded data, a file identifier determination module for identifying the digital data, a hooking module for hooking a command to execute the digital data, and an authenticating module to the digital data purchaser client system by the digital data transaction server, wherein
the digital data purchaser client system performs the steps of recognizing the encoded digital data by means of the file identifier determination module, decoding the encoded digital data on a main memory of the system by means of the decoding module, loading an execution program for executing the decoded digital data on the main memory, analyzing the loaded execution program and recognizing a necessary function module, supplying the authenticating function module to the main memory, changing a call destination address for calling the necessary function module to an entry point address of the authenticating function module by means of the hooking module, executing the authenticating function module instead of the necessary function module when calling the necessary function module in the course of executing the decoded digital data by the execution program, decoding the encoded list of authenticated functions by means of the decoding module and loading the same on the main memory before executing the authenticating function module, determining whether or not the necessary function module belongs to the list of authenticated functions, calling and executing the necessary function module called by the execution program, if the called necessary function module is determined to belong to the list of authenticated functions, and not executing the called necessary function module, if determined otherwise.

3. The transaction method of claim 2, wherein the digital data purchaser client system further performing the steps of:
authenticating a user by accessing a server system remotely located; and
receiving decoding means for decoding the encoded digital data if authenticated as a lawful user
prior to the step of decoding the encoded digital data on the main memory of the computer system.

4. The transaction method of claim 2, wherein the execution program code comprises an import address table (IAT) enlisting necessary function modules required for execution, and the step of analyzing the loaded execution program and recognizing a necessary function module is a step of analyzing and recognizing the IAT.

5. The transaction method of claim 2, wherein the execution program code comprises an import address table (IAT) enlisting necessary function modules required for execution, and the step of changing a call destination address for calling the necessary function module to an entry point address of the authenticating function module is a step of changing a call destination address for calling the IAT to an entry point address of the authenticating function module.

6. The transaction method of claim 2, wherein the digital data purchaser client system further performs the steps of:
authenticating a user by accessing a server system remotely located;
receiving a list of authenticated functions from the server system if authenticated as a lawful user
prior to the step of loading the list of authenticated functions authenticated as being available with respect to the decoded digital data before executing the authenticating function module.

7. The transaction method of claim 2, wherein the necessary function module performs at least any one function of screen viewing, screen storing, screen printing, file editing, file storing, file transmitting, file printing, file encoding, file decoding, sound executing, mobile image executing or program executing.

8. The transaction method of claim 2, wherein the digital data comprises at least any one of execution program code, image data, text data, sound data, still screen data or image data.

9. A program execution method in a computer system including a file identifier determination module, an encoding/decoding module, a hooking module and an authenticating function module, the method comprising the steps of:
downloading encoded digital data and an encoded list of authenticated functions interlocked therewith from a predetermined server remotely located;
recognizing the encoded digital data by the file identifier determination module;
decoding the encoded digital data on a main memory of the computer system by the encoding/decoding module;
loading an execution program capable of executing the decoded digital data on the main memory;
analyzing the loaded execution program and recognizing a required necessary function module;
loading the authenticating function module on the main memory to authenticate operation of the necessary function module;
changing a call destination address for calling the necessary function module from the execution program to an entry point address of the authenticating function module by the hooking module;
executing the authenticating function module instead of the necessary function module when the necessary function module is called in the course of executing the decoded digital data by the execution program;
decoding the encoded list of authenticated functions by means of the encoding/decoding means, and loading the same on the main memory before executing the authenticating function module;
determining whether or not the called necessary function module belongs to the list of authenticated functions by the authenticating function module; and
calling and executing the necessary function module called by the execution program from the authenticating function module if the called necessary function module is determined to belong to the list of authenticated functions, and not executing the called necessary function module if determined otherwise.

10. The program execution method of claim 9, further comprising the steps of:
authenticating a user by accessing a server system remotely located; and
receiving decoding means for decoding the encoded digital data if authenticated as a lawful user
prior to the step of decoding the encoded digital data on the main memory of the computer system.

11. The program execution method of claim 9, wherein the execution program code includes an import address table (IAT) enlisting necessary function modules required for execution, and the step of analyzing the loaded execution program and recognizing a required necessary function module is a step of analyzing the IAT and recognizing the same.

12. The program execution method of claim 11, wherein the execution program code includes the IAT enlisting and calling necessary function modules required for execution, and the step of changing a call destination address for calling the necessary function module from the execution program to an entry point address of the authenticating function module is a step of changing a call destination address of the IAT to an entry point address of the authenticating function module.

13. The program execution method of claim 9, further comprising the steps of:
authenticating a user by accessing a server system remotely located; and
receiving a list of authenticated functions if authenticated as a lawful user
prior to the step of loading the list of authenticated functions authenticated as being available with respect to the decoded digital data before executing the authenticating function module.

14. The program execution method of claim 9, wherein the list of authenticated functions is an encoded file, and the method further comprises the steps of:
authenticating a user by accessing a server system remotely located; and
receiving decoding means for decoding the list of authenticated functions from the server system if authenticated as a lawful user
prior to the step of loading the list of authenticated functions authenticated as being available with respect to the decoded digital data before executing the authenticating function module.

15. The program execution method of claim 9, wherein the necessary function module performs at least any one function of screen viewing, screen storing, screen printing, file editing, file storing, file transmitting, file printing, file encoding, file decoding, sound executing, mobile image executing or program executing.

16. The program execution method of claim 9, wherein the digital data comprises at least any one of execution program code, image data, text data, sound data, still screen data or image data.

17. A recording medium comprising:
decoding means for decoding encoded digital data on a main memory of a computer system;
necessary function module recognizing means for recognizing a required necessary function module by analyzing an execution program capable of executing the digital data loaded on the main memory;
authentication means for authenticating operation of the necessary function module;
hooking means for changing a call destination address of a code for calling the necessary function module among the execution codes of the execution program loaded on the main memory to an entry point address of the authentication means;
a list of authenticated functions authenticated as being available with respect to the decoded digital data; and
determination means for determining whether or not the necessary function module belongs to the list of authenticated functions, whereby
the determination means determines whether or not the called necessary function module is included in the list of authenticated functions if a predetermined necessary function module is called by the execution program, and the authentication means calls the predetermined necessary function module in the affirmative, and does not call the predetermined necessary function module in the negative.
